(19) United States
(12) Patent Application Publication
(10) Pub. No.: US 2026/0116273 A1
(43) Pub. Date: Apr. 30, 2026

(54) ROTATABLE AND TILTABLE CHILD SAFETY SEAT

(71) Applicant: JOURNEY INNOVATION, LLC, Mount Joy, PA (US)

(72) Inventor: Mitchell L. SHELLENBERGER, Mount Joy, PA (US)

(21) Appl. No.: 19/365,816

(22) Filed: Oct. 22, 2025

Related U.S. Application Data
(60) Provisional application No. 63/712,796, filed on Oct. 28, 2024.

(51) Int. Cl. B60N 2/28

(52) U.S. Cl. CPC B60N 2/2869; B60N 2/2806; B60N 2/2821; B60N 2/2875

(57) ABSTRACT

A child safety seat in which a portion can be rotated between rear-facing and forward-facing configuration is disclosed. The child safety seat can also be tilted forward as needed for placement of a child or for accessing the attachment hardware located beneath the tiltable aspect. The rotation and tilting mechanism are separate. A seatbelt pathway is under the titlable aspect, and the safety seat is adapted pull the seatbelt taut when pressed into place.

### FIELD OF THE INVENTION

The present disclosure is generally directed to child safety seats which are typically secured to other seats such as car or airplane seats and the such. More particularly, the subject matter of this application pertains to such child safety seats that can rotate and tilt.

### BACKGROUND OF THE INVENTION

Infant car seats must satisfy two competing demands: they must be securely attached to a vehicle seat to protect the child during travel, yet they must also allow the caregiver to place and remove the child with minimal difficulty. Conventional infant car seats are typically mounted in a fixed orientation using either the vehicle’s seat belt system or integrated latch connectors. Once installed, the seat often becomes cumbersome to manipulate, requiring awkward reaching and lifting motions to position the child and fasten harness straps.

To improve caregiver access, some seats have been developed with rotating bases that allow the seat to pivot toward the vehicle door. Others employ tilting or reclining mechanisms that alter the seat’s orientation to ease child placement. While these designs offer incremental improvements, they introduce new challenges. Rotating seats often involve bulky bases or complex latching mechanisms that are difficult to lock securely into the vehicle seat. Tilting designs frequently rely on stiff linkages or multiple release steps that make operation jerky or unintuitive. In both cases, caregivers may find that the seat is either difficult to install properly or does not move smoothly during use.

Accordingly, there remains a need for an infant car seat that combines secure installation with intuitive, smooth operation. Such a design should reduce the likelihood of improper attachment, simplify caregiver interaction, and still maintain robust safety performance.

### SUMMARY OF THE INVENTION

The subject matter of this application addresses these needs.

The subject matter of this application pertains to methods and devices for transporting children in safety car seats and goods. In particular, we disclose a child safety seat assembly comprised of a base, and a two-membered shell. One component of the shell is pivotably attached to the base via a hinge structure, and the platform may be tilted forward, allowing access to the base and to the structures, such as a seatbelt or lower anchors and tethers for children (LATCH), used to secure the base to the vehicle. Further, another component of the shell is rotationally coupled to the first component so that the seat can be rotated to form a front or rear-facing seat and could be rotated such that the seat faces the caregiver placing the child in or out of the safety car seat. In another aspect of the subject matter of this application, securing the shell to the base presses a securing seat belt between a notch and a tab, further tightening the belt.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF DRAWINGS

FIG. 1 illustrates a child safety seat as described in a forward-facing. non-tilted position.

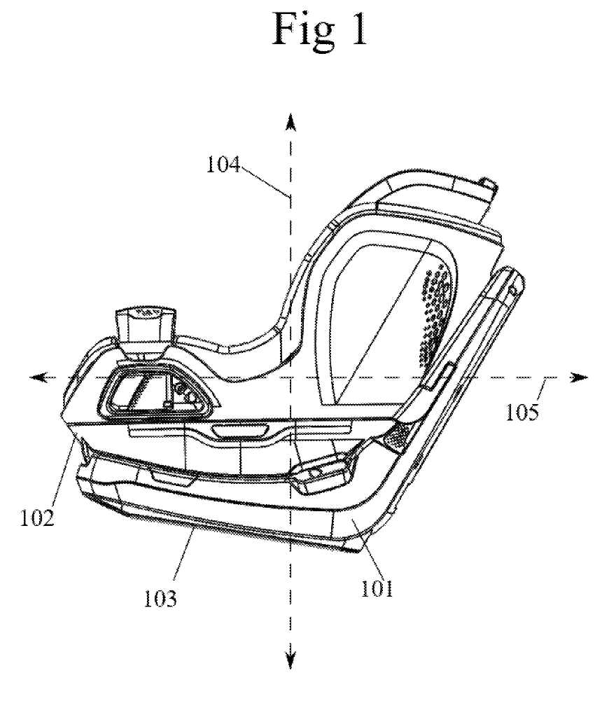

FIG. 2 illustrates a view of a child safety seat including an optional adjustment foot.

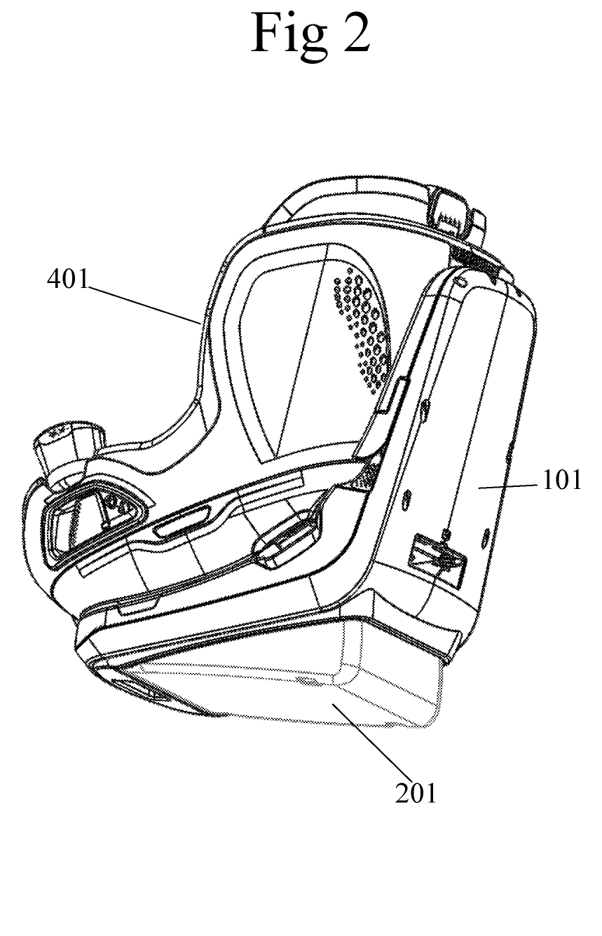

FIG. 3 illustrates a view of a child safety seat as described in a rear-facing position.

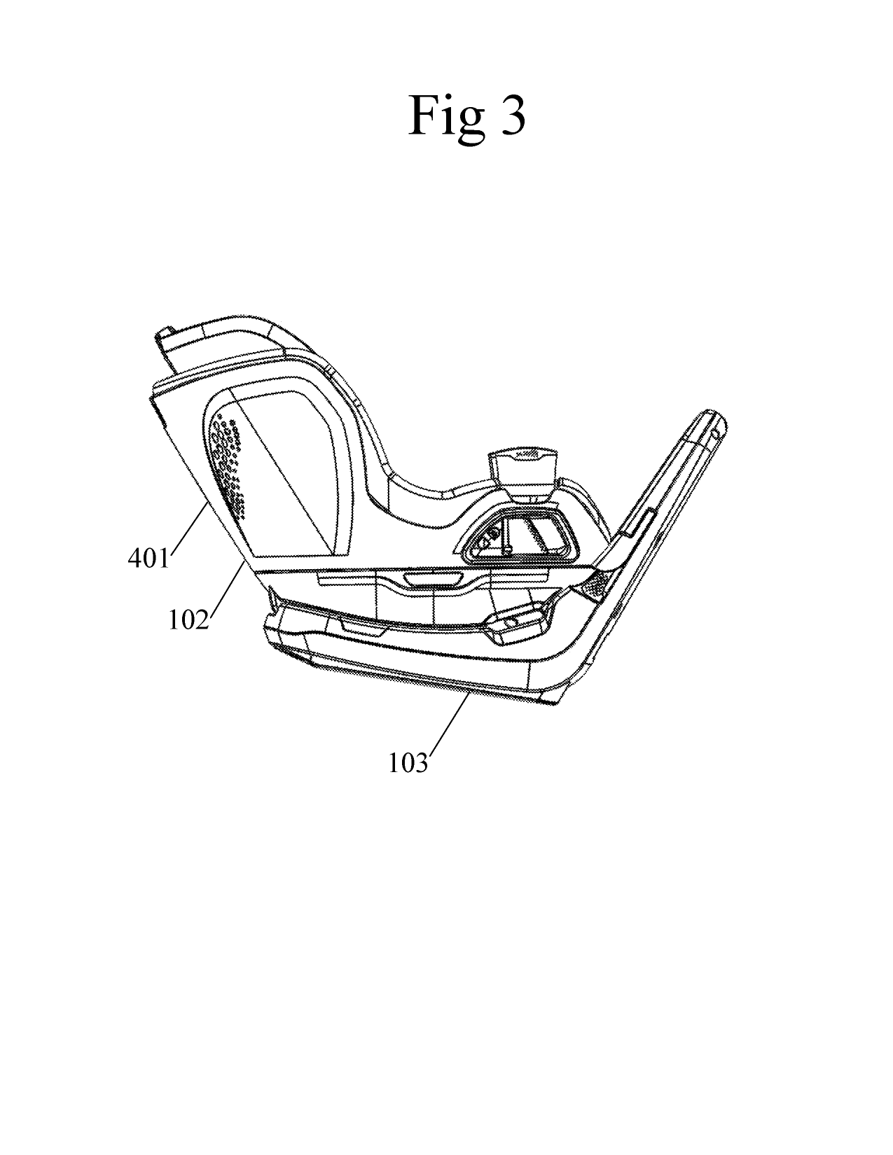

FIG. 4 is a view of a child safety seat rotated mid-way between a forward-dacing position and a rear-facing position

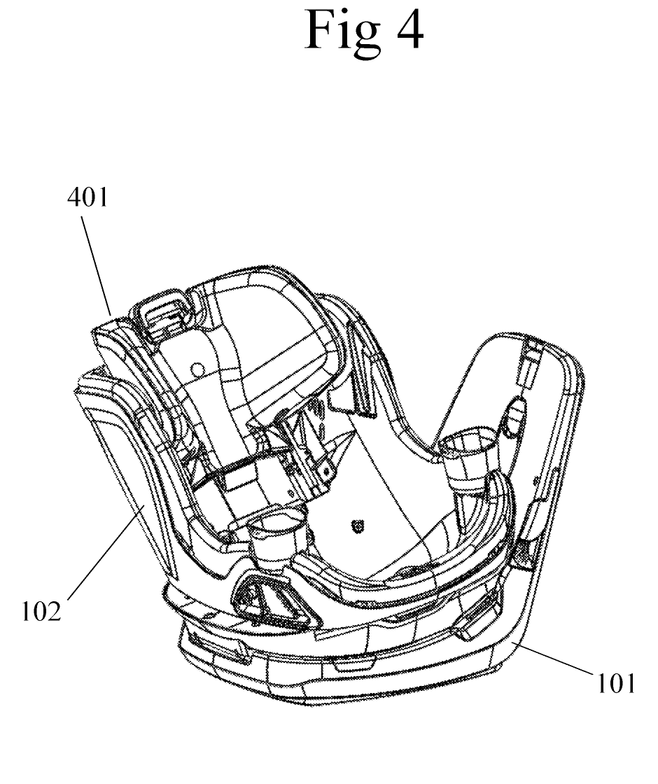

FIG. 5 is a view of the frame of the base, isolated from the rest of the child safety seat.

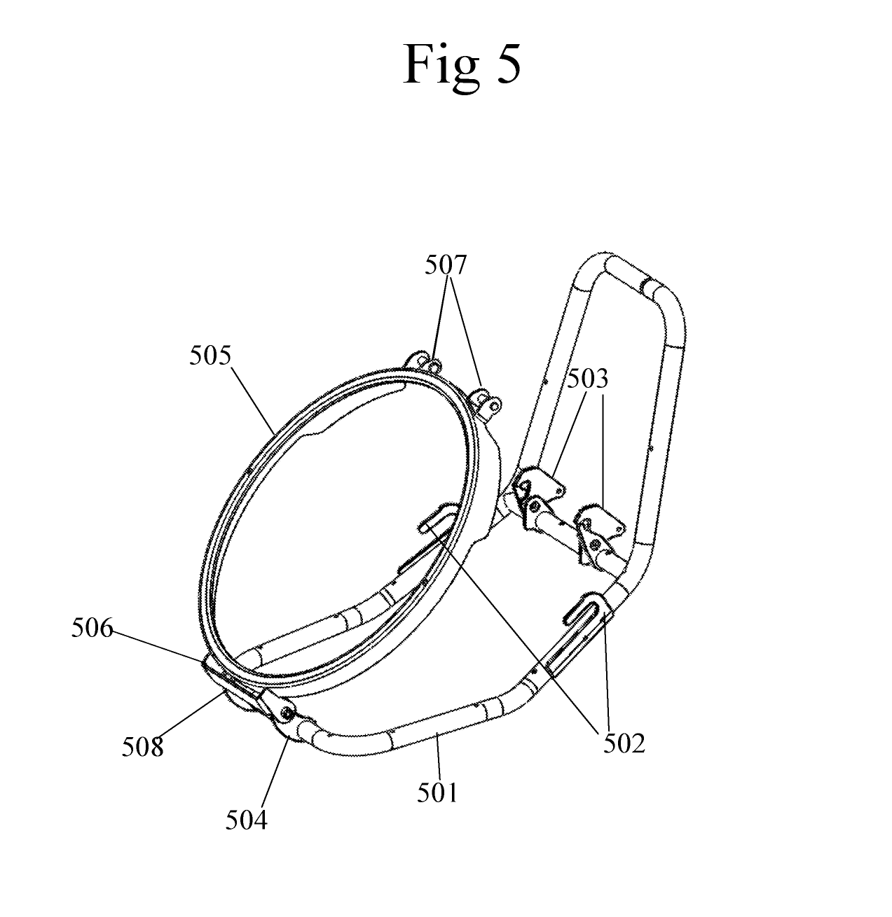

FIG. 6 is a view of the child safety seat tilted forward.

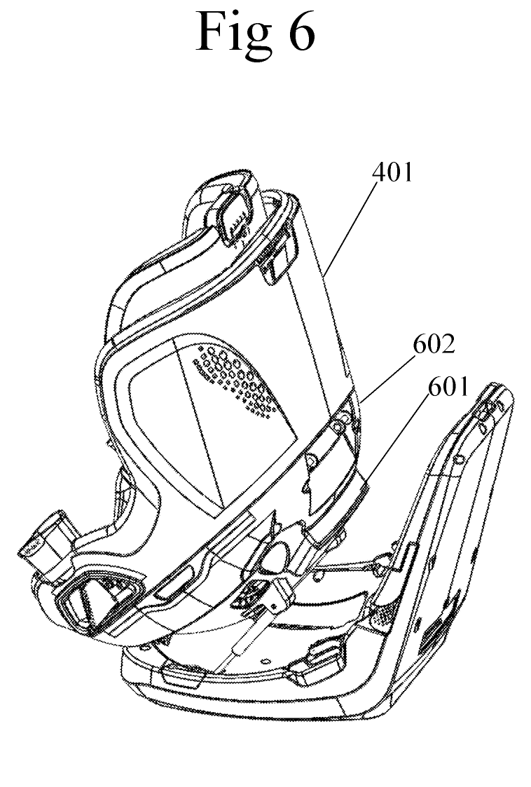

FIG. 7 is another view of of the child safety seat titled forward.

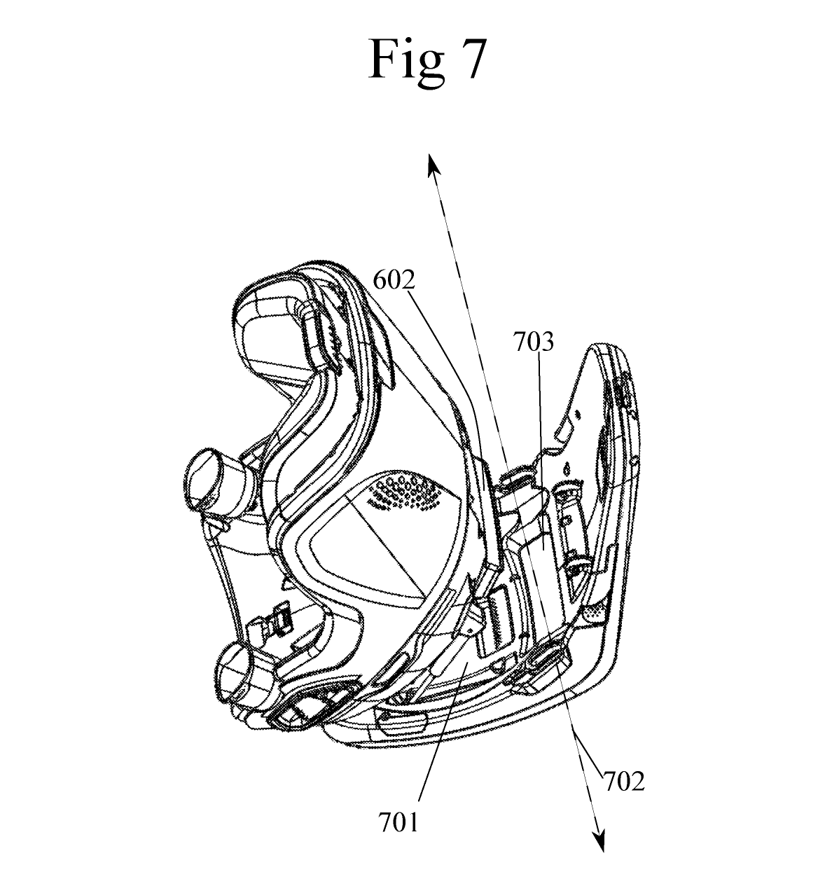

FIG. 8 is another view of the child safety seat in a forward facing, non-tilted position.

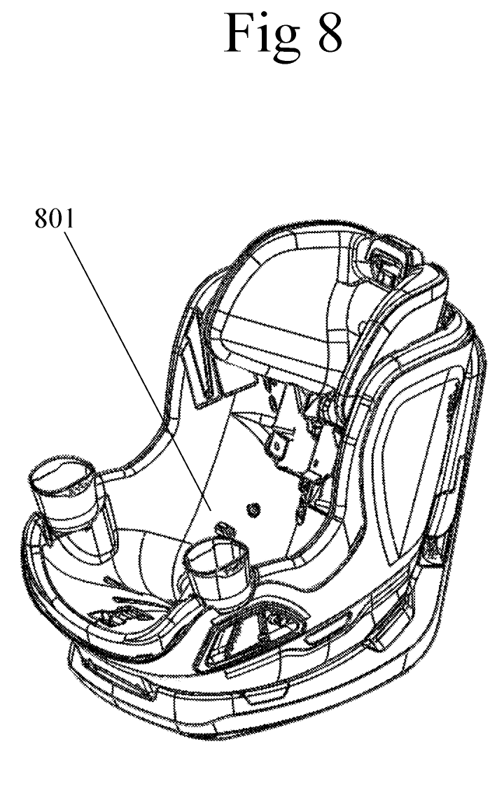

FIG. 9 is a view of the frame of the base, in a non-tilted position.

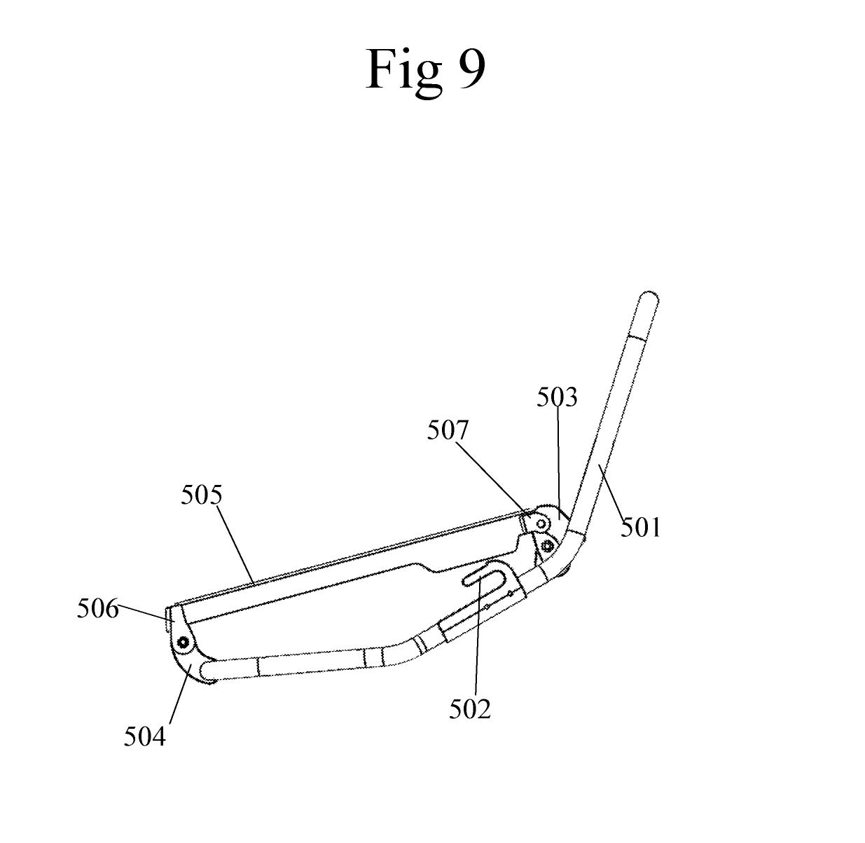

FIG. 10 is a lower/rear exploded view of the child safety seat.

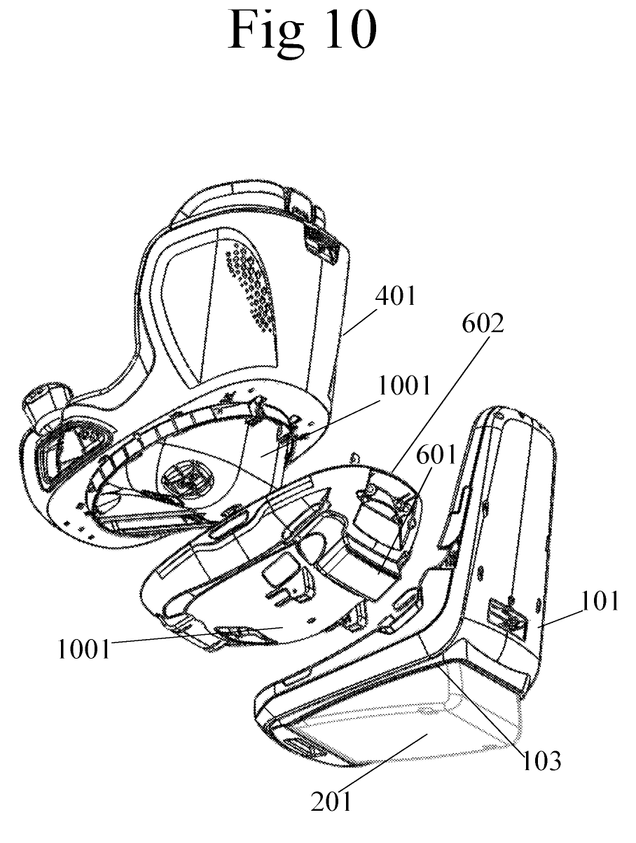

FIG. 11 is an upper/front exploded view of the child safety seat.

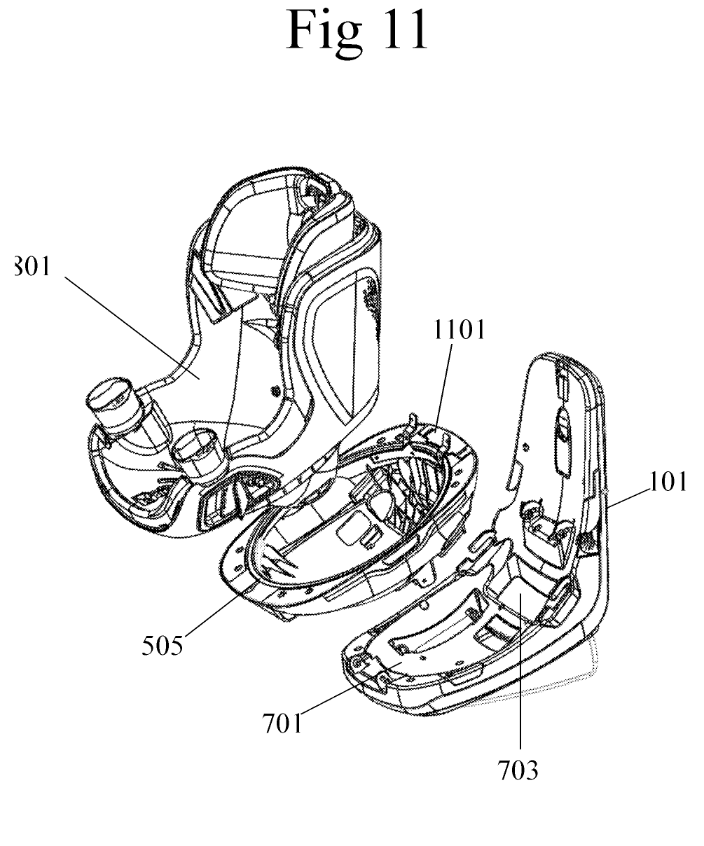

The same reference numbers will be used throughout the drawings to represent the same parts wherever possible.

### DETAILED DESCRIPTION OF THE INVENTION

While the exemplary embodiments illustrated in the figures and described herein are presently preferred, it should be understood that these embodiments are only examples. Accordingly, the present application is not limited to a particular embodiment but extends to various modifications that fall within the scope of the appended claims. The order or sequence of any processes or method steps may be varied or re-sequenced according to alternative embodiments.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating conditions, and arrangement of the exemplary embodiments without departing from the scope of the present application.

Uses of the verbs ‘include’ and ‘have’ should be understood to mean ‘comprise,’ i.e., the terms are inclusive and open-ended and do not exclude additional elements or steps.

Reference numbers are given as three digits. The first digit refers to the illustration in which the referenced item is first, or best shown.

A rotatable and tiltable child safety seat (the “Seat”) comprises a base (101) and a shell (102). The base has a top aspect (701) and a bottom aspect (103). When the Seat is positioned for use in a car, the bottom aspect in largely in contact with the seat of the car. The Seat has a horizontal axis (702), a vertical (104), and an axial axis (105). The seat also has at least one, but preferably two, seat belt hooks (502) through which a vehicle seatbelt is run, defining a seatbelt path. A portion of the seatbelt path runs over the first part of a two-part belt tightening system. In most highly preferred embodiments, this first part is a cavity (703) in the top aspect of the base. The base further comprises a frame (501). In most highly preferred embodiments, this frame is a metal tube or similar structure which is predominantly hidden from view within the base. In most preferred embodiments, the base exposes two aspects of the frame: a first connection point (503), and a second connection point (504).

In some embodiments, the bottom aspect of the base further comprises a foot (201) that can be positioned to adjust the axial axis of the Seat.

The shell is comprised of two components, a tilting component (602) and a rotating component (401).

The tilting component has a top aspect (1101) and a bottom aspect (1001). The bottom aspect of the tilting component comprises a second part of a two-part belt tightening system. In a most highly preferred embodiment, this second component is a projection (601) adapted to fit within the said cavity of the base component. The tilting component further comprises a circular track (505) having a plane, in which the plane of the circle is largely parallel to the horizontal and the axial axes of the Seat. The circular track further comprises a first connection point (506) and a second connection point (507). The first connection point of the circular track is hingedly connected (508) to the first connection point of the frame of the base. The second connection point of the circular track comprises a first part (507) of a two-part locking system, and the second connection point of the frame of base comprises a second part (503) of said two-part locking system.

In the most highly preferred embodiment, the tilting component can be rotated along the hinged connection from a seated conformation where the bottom aspect of the tilting component of the shell is largely in contact with the top aspect of the base, to a tilted forward conformation. When rotated to the seated conformation the two parts of the two-part locking system engage, looking the seat in place. Pressing the tilting component into the seated conformation further causes the two parts of the two-part belt tightening system to interact. In a most common use, the seatbelt of the car is held by the seatbelt hooks and is within the seatbelt path. Engagement of the two-part belt tightening system causes the seatbelt to be further tightened. In the most highly preferred embodiment, the projection on the tilting component is inserted into the cavity of the base component, and the belt is further tightened as it is driven inside the cavity by the projection. In most highly preferred embodiments the bottom of the tilting component and the top of the base component

The rotating component has a top aspect (801) and a bottom aspect (1001). The bottom aspect has at least two support assemblies adapted to interact with the track of the tilting component rotationally. Preferably, these support assemblies are connected to said track in a way that allows the rotating component to rotate along the track but also holds the rotating component to the tilting component so that the bottom aspect of the rotating component is largely in contact with the top aspect of the tilting component. In a highly preferred embodiment, these support assemblies comprise running wheels positioned on top of the track to support the rotating component and up-stop wheels to prevent the rotating component from lifting off the track. Other preferred embodiments incorporate ball-bearing structures similar in function to the wheel assembly. The Seat further comprises one or more stops which interact with the rotating component to prevent rotational movement when engaged.

The top aspect of the rotating component of the shell is normally covered in a soft material is provide comfortable seating surface for a child. In a most highly preferred embodiment, the lowest part of the seated child’s buttocks are at least partially surrounded by the track.

1. A child safety car seat comprising a base and a shell, in which said shell is adapted to allow for rotation and also adapted to allow for tilting.

2. The child safety car seat of claim 1 in which said shell is comprised of a first component and a second component,

3. The child safety car seat of claim 2 in which the base comprises a frame predominantly hidden from view.

4. The child safety car seat of claim 2 in which:

5. The child safety car seat of claim 4 in which the base further comprises a belt path structure which creates a seatbelt pathway.

6. The child safety car seat of claim 5 in which the placing the second component of the shell into the fully tilted forward position allows access to the seatbelt pathway, and placing the second component of the shell into the fully tilted back position causes the distance traveled by a seatbelt in the seatbelt pathway to increase.

7. A child safety car seat comprising:
a base having a top aspect and a bottom aspect, the base including a frame substantially embedded within the base, the frame having a first connection point and a second connection point;
a shell comprising a tilting component and a rotating component;
the tilting component including a circular track having a first connection point, a second connection point, a top aspect, and a bottom aspect; and
the rotating component having a top aspect and a bottom aspect;
wherein the top aspect of the base and the bottom aspect of the tilting component are in contact when the car seat is in the non-tilted conformation;
wherein the first connection point of the frame is hingedly connected to the first connection point of the circular track;
wherein the second connection point of the frame includes a first component of a two-component attachment means, and the second connection point of the circular track includes a second component of the two-component attachment means;
wherein the top aspect of the base and the bottom aspect of the tilting component are further connected by at least one strut, each said strut being compressed when the car seat is in the non-tilted conformation;
wherein the top aspect of the base comprises a first member of a belt tightening system and the bottom aspect of the tilting component comprises a second member of a belt tightening system; and
wherein the bottom aspect of the rotating component is in contact with the top aspect of the tilting component, and the rotating component is rotatably connected to the circular track of the tilting component.

8. The child safety car seat of claim 7 wherein securing the second connection point of the frame to the second connection point of the circular track causes the engagement of the two-component belt-tightening system.

9. The child safety car seat of claim 7 in which the top aspect of the rotating component is predominantly covered in a soft material and in which at least a portion of this material is located within the track.
